(19) United States
(12) Patent Application Publication
(10) Pub. No.: US 2025/0067694 A1
(43) Pub. Date: Feb. 27, 2025

(54) SENSORS HAVING A COMPOSITE OF CARBON NANOTUBES DECORATED WITH NANOPARTICLES AND SENSING NITRIC OXIDE

(71) Applicant: United States of America as represented by the Administrator of NASA, Washington, DC (US)

(72) Inventors: Ami M Hannon, MOFFETT FIELD, CA (US); Jing Li, MOFFETT FIELD, CA (US)

(21) Appl. No.: 18/815,834

(22) Filed: Aug. 26, 2024

Related U.S. Application Data
(60) Provisional application No. 63/578,980, filed on Aug. 25, 2023.

(51) Int. Cl. G01N 27/06

(52) U.S. Cl. CPC G01N 27/06

(57) ABSTRACT

Sensors effective for detecting nitric oxide over a wide range of humidity conditions (up to 97% relative humidity) may comprise: an electrically conductive structure; and a composite in electrical communication with the electrically conductive structure. The composite comprises a plurality of metal nanoparticles and oxidized carbon nanotubes comprising a plurality of carboxylic acid moieties, in which the oxidized carbon nanotubes are decorated with the plurality of metal nanoparticles. A concentration of metal nanoparticles in the composite is optimized to provide an electrical response that is correlatable to a concentration of nitric oxide exposed thereto. Further selections may be made in view of humidity conditions.

### CROSS-REFERENCE TO RELATED APPLICATIONS

This application claims priority to U.S. Provisional Application No. 63/578,980, filed on Aug. 25, 2023, which is hereby incorporated by reference as if fully set forth herein.

### ORIGIN OF THE INVENTION

The invention described herein was made in the performance of work under a NASA contract and by an employee of the United States Government and is subject to the provisions of Public Law 96-517 (35 U.S.C. § 202) and may be manufactured and used by or for the Government for governmental purposes without the payment of any royalties thereon or therefore. In accordance with 35 U.S.C. § 202, the contractor has elected not to retain title.

### FIELD

Embodiments of the present disclosure relate to sensing and, more particularly, sensing of trace nitric oxide in fluids using sensors featuring a composite comprising at least one nanomaterial.

### BACKGROUND

Nitric oxide (NO) is a recognized atmospheric pollutant and potential health hazard. According to the Occupational Safety and Health Administration (OSHA), the permissible exposure limit (PEL) for nitric oxide gas is 25 ppm. Lower levels of nitric oxide may be found in a person's exhaled breath as a consequence of natural metabolic processes. Deviation of nitric oxide levels from baseline in a person's breath may be indicative of a diseases state, such as neurodegenerative diseases or respiratory conditions. For example, an average, healthy person typically has an exhaled nitric oxide concentration of approximately 6.7-16.2 parts per billion (ppb), while the exhaled breath of an asthma patient may have a concentration in the range of approximately 34.7-51.1 ppb. Accordingly, detection and monitoring of nitric oxide has applicability in a wide range of fields, such as environmental monitoring, industrial process control, combustion studies, oceanographic studies, and medical diagnoses, just to name a few.

Although of great potential utility, sensing technologies suitable to analyze a wide range of nitric oxide concentrations in disparate types of media are not currently available. It is currently possible to measure trace gases including nitric oxide, nitrous oxide (N₂O), and dimethyl sulfide (DMS) in the atmosphere (i.e., as a gas) in real-time or near real-time using conventional sensor technology. In contrast, conventional sensor technologies suitable to assay for dissolved gases in seawater and other fluids in real-time or near real-time are limited to carbon dioxide (CO₂), methane (CH₄), and hydrogen sulfide (H₂S). At present, measurement of dissolved gases like N₂O and NO rely on labor-intensive, laboratory-based analyses, such as mass spectrometry and gas chromatography, and are not considered amenable to real-time or near real-time analyses.

Nitric oxide is a highly unstable and reactive free-radical molecule. Detection of such molecules is relatively difficult, especially at low concentrations and in high humidity environments. Currently, the most commonly used techniques to monitor nitric oxide are electrochemical devices, electron paramagnetic resonance spectroscopy, chemiluminescence, transistor-based devices, and X-ray photoelectron spectroscopy. There is no one preferred technique universally suited to detect nitric oxide under varying conditions or environments (e.g., in vivo or in situ, in a range of fluids, and/or over a wide range of concentration values). Moreover, expensive instrumentation and complex, time-consuming analyses may be needed in some cases.

Direct sensing of nitric oxide using dedicated, nitric oxide-specific sensors has been sparsely reported, and even these techniques have practical limitations. Detection of nitric oxide using metal oxide (e.g., WO₃, Cr₂O₃, In₂O₃, ZnO, or SnO₂) sensors typically occurs at high temperatures (350-800°° C.), thereby requiring high power consumption. In addition, the selectivity for nitric oxide tends to be poor under these conditions. Conducting polymers, such as polyethyleneimine or polyaniline, for example, or conducting polymer composites such as polyaniline/WO₃, for example, have also been studied. Although conducting polymers or composites thereof may provide good sensitivity, they are frequently sensitive to water and may provide inconsistent results depending on the humidity level.

### SUMMARY

In various embodiments, the present disclosure provides sensors comprising: an electrically conductive structure; a composite in electrical communication with the electrically conductive structure, the composite comprising functionalized carbon nanotubes decorated with a plurality of metal nanoparticles; and a humidity sensor in proximity to the composite.

In some or other embodiments, the present disclosure provides sensors comprising: an electrically conductive structure; and a composite in electrical communication with the electrically conductive structure, the composite comprising a plurality of metal nanoparticles and oxidized carbon nanotubes comprising a plurality of carboxylic acid moieties; wherein the oxidized carbon nanotubes are decorated with the plurality of metal nanoparticles; and wherein a concentration of metal nanoparticles in the composite is optimized to provide an electrical response that is correlatable to a concentration of nitric oxide exposed thereto.

In still other various embodiments, the present disclosure provides methods for detecting nitric oxide. The methods comprise: providing a sensor comprising an electrically conductive structure and a composite in electrical communication with the electrically conductive structure; wherein the composite comprises functionalized carbon nanotubes decorated with a plurality of metal nanoparticles; contacting a fluid comprising nitric oxide with the composite; determining an electrical response of the composite upon contacting the fluid therewith; and correlating the electrical response with a concentration of nitric oxide present in the fluid.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a diagram of a sensing mechanism for sensing nitric oxide, having a composite of functionalized carbon nanotubes that are decorated with a plurality of gold nanoparticles, according to some embodiments.

FIG. 2A is a plot of current versus potential for Sensors 3 and 5. FIG. 2B is a plot of normalized sensor response as a function of time illustrating the response of Sensors 1-4 in a nitrogen background (0% relative humidity). FIG. 2C is a corresponding plot of normalized sensor response as a function of nitric oxide concentration for Sensors 1-4 in a nitrogen background.

FIG. 3A is a plot of normalized sensor response as a function of time for Sensors 1-4 at 92% relative humidity. FIG. 3B is a corresponding plot of normalized sensor response as a function of nitric oxide concentration for Sensors 1-4 at 92% relative humidity.

FIG. 4A is a plot of normalized sensor response as a function of time for four replicates of Sensor 3 in a nitrogen background (0% relative humidity). FIG. 4B is a corresponding plot of normalized sensor response as a function of nitric oxide concentration for four replicates of Sensor 3 in a nitrogen background.

FIG. 5A is a plot of normalized sensor response as a function of time for four replicates of Sensor 5 in 97% relative humidity. FIG. 5B is a corresponding plot of normalized sensor response as a function of nitric oxide concentration for four replicates of Sensor 5 at 97% relative humidity.

FIGS. 6A-6F are plots of normalized sensor response for Sensor 3 under variable humidity conditions. FIG. 6G is a corresponding plot of normalized sensor response as a function of nitric oxide concentration for Sensor 3 under variable humidity conditions.

FIGS. 7A-7F are plots of normalized sensor response for Sensor 5 under variable humidity conditions. FIG. 7G is a corresponding plot of normalized sensor response as a function of nitric oxide concentration for Sensor 5 under variable humidity conditions.

FIG. 8 is a bar graph showing the normalized sensor response for Sensors 3 and 5 when exposed to various environmental gases at 0% relative humidity.

### DETAILED DESCRIPTION

Embodiments of the present disclosure relate to sensing and, more particularly, sensing of trace nitric oxide in fluids using sensors featuring a composite comprising at least one nanomaterial.

As discussed above, there are difficulties associated with sensing nitric oxide in various media and over a diverse range of concentrations and/or environmental conditions. In some cases, expensive instrumentation and complex and/or time-consuming analyses may be needed.

In response to the foregoing, the present disclosure provides sensors and methods utilizing a composite containing at least one nanomaterial that may provide an analytically detectable response when exposed to nitric oxide. Namely, the sensors and associated methods described herein may utilize a composite (e.g., a composite layer) containing functionalized carbon nanotubes that are decorated (i.e., partially coated upon an outer surface thereof) with a plurality of metal nanoparticles. The metal nanoparticles may be covalently or non-covalently bound to the functionalized carbon nanotubes. In particular examples, the functionalized carbon nanotubes are oxidized single-walled carbon nanotubes containing a plurality of carboxylic acid moieties, and the nanoparticles are gold nanoparticles, as this combination may be particularly effective for interacting with nitric oxide in an analytically detectable manner under a range of conditions. Detection may take place through electrical interrogation, for example.

Surprisingly and advantageously, according to some embodiments, the amount or concentration of metal nanoparticles (e.g., gold nanoparticles) bound to carbon nanotubes in the composite material are selected to provide an optimized electrical response that is correlated with a concentration of nitric oxide interacting with the sensors. According to some embodiments, the amount or concentration of metal nanoparticles is selected based upon the anticipated humidity conditions under which the sensors will be operating, among other factors. Selection of the amount of metal nanoparticles based upon the humidity conditions and/or the anticipated amount of nitric oxide may afford a more accurate determination of the amount of nitric oxide that is present, as explained further herein.

Further surprisingly and advantageously, by utilizing oxidized single-walled carbon nanotubes (e.g., oxidized single-walled carbon nanotubes containing a plurality of carboxylic acid moieties) in combination with the metal nanoparticles, in some embodiments, the protonation state of the carbon nanotubes may be altered to afford an electrical response that is more tolerant of humidity upon exposure to nitric oxide. Like the amount of metal nanoparticles that are present, the extent of protonation or deprotonation of the carboxylic acid moieties may be selected to afford a more accurate determination of nitric oxide concentration or quantity under specified humidity conditions. Accordingly, sensors of the present disclosure in some embodiments are configured to operate under a range of environmental conditions, including at least variable humidity conditions, and afford a response that is correlated to an amount of nitric oxide that is present under such conditions. Tolerance to high humidity levels may be beneficial to facilitate direct detection of nitric oxide in aqueous fluids or in exhaled breath, or in the gaseous headspace above an aqueous fluid, for example.

Without being bound by theory or mechanism, the composite may facilitate detection by adsorbing nitric oxide from a fluid onto the metal nanoparticles and/or the carbon nanotubes and undergoing a change in at least one electrical property to produce an electrical response, which is detected by the sensor system. Depending on the intended application, the fluid may be a gas or liquid,. Detection of the change in the electrical property allows the electrical response to be correlated to a concentration of nitric oxide that is present in the fluid. For example, the change in resistance of the composite may facilitate determination of the concentration of nitric oxide in the fluid. Advantageously, the sensors and methods of the present disclosure may suitably detect and quantify nitric oxide at single-digit ppm levels and lower, and may offer an ultimate detection limit approaching 10 ppb or even lower.

Still other advantages offered by the sensors and methods of the present disclosure may include the ability to conduct analyses in real-time or near real-time while operating with low power requirements. Easy operability and a small operating footprint may represent additional advantages of the sensors described herein. All of the foregoing represent significant advantages and advancements over conventional techniques for detection of nitric oxide.

Applications for the sensors and methods of the present disclosure are therefore wide-ranging and may include, for example, analysis of exhaled breath for quantifying nitric oxide as a biomarker of disease states or conditions, such as lung or neurological diseases; environmental analyses, including air or water monitoring; or industrial process analyses, such as combustion stream monitoring, for example.

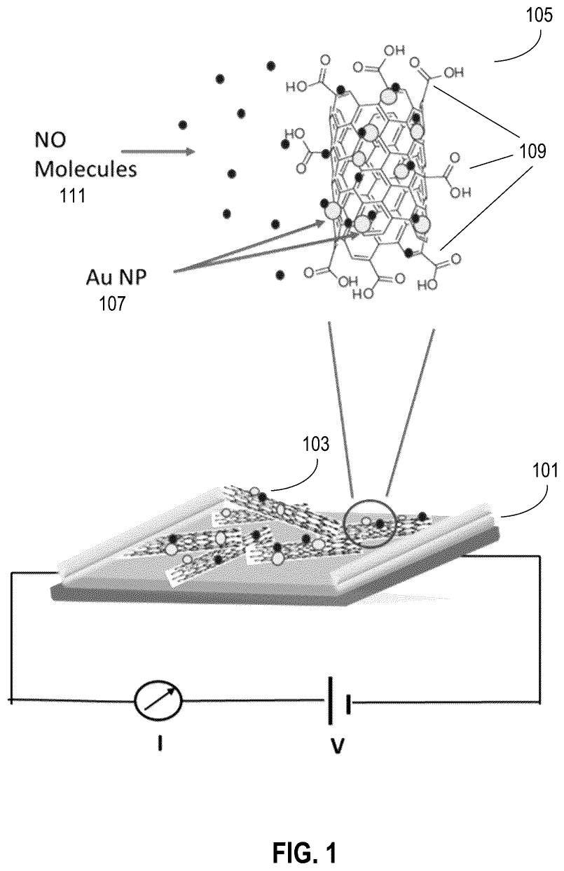

Accordingly, with reference to FIG. 1, some of embodiments of sensors of the present disclosure may comprise: an electrically conductive structure 101; and a composite 103 in electrical communication with the electrically conductive structure, in which the composite comprises functionalized carbon nanotubes 105 decorated with a plurality of metal nanoparticles 107. In some embodiments, the sensors comprise an electrically conductive structure; and a composite in electrical communication with the electrically conductive structure, in which the composite comprises a plurality of metal nanoparticles and oxidized carbon nanotubes comprising a plurality of carboxylic acid moieties 109, and the oxidized carbon nanotubes are decorated with the plurality of metal nanoparticles. While the example shown in FIG. 1 are specifically nanoparticles of gold, this example is non-limiting and other metal nanoparticles may be used in other embodiments. In some embodiments, an amount or concentration of metal nanoparticles in the composite is optimized to provide an electrical response that is correlatable to a particular amount or concentration of nitric oxide 111 exposed thereto (i.e., when the composite is exposed to nitric oxide during use). In some embodiments, the protonation state of the oxidized carbon nanotubes is altered similarly to provide an electrical response that is correlatable to the amount or concentration of nitric oxide that is present in a sample exposed to the composite. The electrical response is considered to be correlatable to the amount of nitric oxide present when the response is fit to a calibration function over a range of nitric oxide concentrations, for example.

In non-limiting examples, the electrically conductive structure of the sensors may comprise an electrically conductive layer. The electrically conductive layer may comprise at least a first electrode and a second electrode, such as a cathode and an anode. For example, the electrically conductive structure may comprise an interdigitated electrode, with the composite placed in electrical communication with the interdigitated electrode by drop-casting a dispersion of the composite thereon. Other electrode configurations for the electrically conductive layer are possible, such as configurations in which more than two electrodes are present. Likewise, other techniques for placing the composite in electrical communication with the electrically conductive layer may also be suitable, such as spraying, chemical vapor deposition (CVD), pipetting, spin-coating, dip-coating, and the like. The electrically conductive layer may allow the composite to be interrogated in a suitable manner to determine a change in at least one electrical property (an electrical response) for facilitating detection and quantification of nitric oxide according to the disclosure herein.

The electrically conductive structure may be formed or placed on a dielectric substrate, such as a non-conductive polymer (e.g., epoxy resins, polyesters, or the like). The electrically conductive structure may comprise one or more conductive materials such as, for example, gold, copper, graphite, titanium, silver, or platinum, including any combination, composite, or alloy thereof, which may be deposited upon the dielectric substrate by techniques such as, for example, vacuum deposition, printing, etching, milling, or the like.

A measurement device may be connected to the electrically conductive structure for interrogating at least one electrical property of the composite, such as resistance. Other electrical properties that may be interrogated include, but are not limited to, drain current, threshold voltage, mobility, and the like. The change in the at least one electrical property (e.g., from a first state to a second state or against background conditions) represents an electrical response that may be correlated with the amount of nitric oxide that is present.

In any embodiment described herein, the functionalized carbon nanotubes may be prepared from single-walled carbon nanotubes (SWNTs), multi-walled carbon nanotubes (MWCNTs), or any combination thereof. In particular examples, the composites of the present disclosure may comprise or consist essentially of at least functionalized single-walled carbon nanotubes, in addition to the metal nanoparticles. Single-walled carbon nanotubes may be especially beneficial due to their high electrical conductivity and their ability to interact effectively with nitric oxide in combination with metal nanoparticles according to the disclosure herein.

Oxidized carbon nanotubes are known to those having ordinary skill in the art and may be prepared by reacting carbon nanotubes (e.g., SWNTs and/or MWNTs) with a mixture of sulfuric acid and nitric acid under heating conditions. Such conditions may oxidatively open the curved ends of the carbon nanotubes and place a plurality of carboxylic acid moieties and hydroxyl moieties at the open ends of the carbon nanotubes. Defect sites along the length of the carbon nanotubes may also be created. Such oxidized carbon nanotubes may be referred to equivalently herein as carboxylic acid-functionalized carbon nanotubes or COOH-carbon nanotubes. The carboxylic acid moieties and defect sites may be particularly effective for localizing metal nanoparticles upon the surface of the carbon nanotubes. The locations of the metal nanoparticles are not limited to these locations, however.

Because of their acidity, at least a portion of the carboxylic acid moieties in the oxidized carbon nanotubes may be neutralized with a base. Suitable bases may include, but are not limited to, alkali metal bases (e.g., lithium hydroxide, sodium hydroxide, potassium hydroxide), aqueous ammonia, or any combination thereof. When at least partially neutralized with a base, up to about 10%, or up to about 20%, or up to about 30%, or up to about 40%, or up to about 50%, or up to about 60%, or up to about 70%, or up to about 80%, or up to about 90%, or up to about 100% of the carboxylic acid moieties may be neutralized by conversion to a corresponding salt. Full neutralization of the carboxylic acid moieties may take place in some cases. As discussed in further detail hereinbelow, at least partial neutralization of the carboxylic acid moieties in oxidized carbon nanotubes may be especially beneficial for promoting humidity tolerance of the sensors described herein.

In non-limiting examples, the carbon nanotubes may have a diameter of about 0.3 nanometer (nm) to about 500 nm, or about 5 nm to about 500 nm, or about 5 nm to about 100 nm, or about 1 nm to about 50 nm. The carbon nanotubes may have a length of about 0.001 millimeter (mm) (i.e., 1 micron) to about 20 mm, or about 0.001 mm to about 10 mm. The carbon nanotubes may have an aspect ratio of about 500 or greater, or about 1000 or greater, such as about 500 to about 2000, or about 500 to about 10,000, or about 1000 to about 10,000, or about 10,000 to about 50,000, or even greater than 50,000. In some examples, the carbon nanotubes may be single-walled carbon nanotubes having diameters ranging from about 0.3 nm to 10 nm or about 0.4 nm to about 6 nm, and an aspect ratio ranging from about 102 to about 108. In the case of oxidized carbon nanotubes (e.g., oxidized single-walled carbon nanotubes), the foregoing values represent the carbon nanotube properties prior to oxidation, which may result in shortening of the carbon nanotube upon opening the curved ends of the carbon nanotubes.

The amount of metal nanoparticles in the composite of the sensors described herein may be optimized to provide an electrical response that is correlatable to a concentration of nitric oxide exposed to the sensor. In general, the electrical response of the sensors may increase as the quantity of metal nanoparticles in the sensors increases. However, if excessive metal nanoparticles are present, the sensor response may no longer vary in proportion to the amount of nitric oxide that is exposed to the sensor. Conversely, if the quantity of metal nanoparticles is too low, a detection limit of the sensors may become inadequate. In non-limiting examples, the quantity of metal nanoparticles in the composites may range from about 1 wt % to about 10 wt %, based on a total mass of the composite. Again, however, it is to be emphasized that the actual quantity of metal nanoparticles may be selected based upon variables such as actual sensor performance under particular environmental conditions, the protonation state of the carbon nanotubes, the type(s) of metal nanoparticles present, and the like. Accordingly, it is additionally contemplated that metal nanoparticle quantities outside the 1 wt % to 10 wt % range may also be suitable in some circumstances.

Suitable metal nanoparticles may contain zero-valent metal (i.e., be metallic) and have a size of about 1 nm to about 50 nm, or about 5 nm to about 40 nm, or about 10 nm to about 25 nm, or about 10 nm to about 20 nm. The metal nanoparticles may be spherical or non-spherical in shape and may optionally include at least a partial surfactant coating thereon. Preferably, the metal nanoparticles may lack a surfactant coating to facilitate electrical interactions between the metal nanoparticles and the carbon nanotubes.

In some embodiments, the sensors of the present disclosure may contain composites in which the metal nanoparticles comprise gold nanoparticles. For example, suitable gold nanoparticles prepared by reduction of a gold precursor may have an average diameter of about 15 nm. Other suitable metal nanoparticles may include other highly conductive metals such as, for example, silver, platinum, and palladium.

As indicated above, it may be desirable to know the humidity in proximity to the composite of the sensors, since the sensor response may change with the humidity value. A humidity sensor may be placed “in proximity” to the composite if the humidity sensor is located above, below, or to the side of the composite and in a flowpath of a fluid containing nitric oxide that is being provided to the sensor or exiting the sensor. A humidity sensor may further be considered in proximity to the composite if the humidity sensor provides sampling and analyses that are representative of the humidity conditions to which the sensor is exposed. In so placing the humidity sensor, the humidity sensor may account for environmental humidity and the humidity of the fluid being provided to the sensor. Suitable humidity sensors are not believed to be especially limited and may be selected by one having ordinary skill in the art.

Accordingly, in particular examples, sensors of the present disclosure may comprise: an electrically conductive structure; a composite in electrical communication with the electrically conductive structure, in which the composite comprises functionalized carbon nanotubes decorated with a plurality of metal nanoparticles; and a humidity sensor in proximity to the composite. Suitable functionalized carbon nanotubes and metal nanoparticles are described in more detail above.

Methods for sensing nitric oxide according to the present disclosure may comprise: providing a sensor comprising an electrically conductive structure and a composite in electrical communication with the electrically conductive structure, in which the composite comprises functionalized carbon nanotubes decorated with a plurality of metal nanoparticles; contacting a fluid comprising nitric oxide with the composite; determining an electrical response of the composite upon contacting the fluid therewith; and correlating the electrical response with a concentration of nitric oxide in the fluid.

Fluids suitable for being analyzed for nitric oxide according to the present disclosure are not believed to be particularly limited. In some examples, the fluid may be a gas, and the gas may comprise gaseous nitric oxide. In other examples, the fluid may be a liquid, and the liquid may contain dissolved nitric oxide. In still other examples, the fluid may be a gas obtained from the headspace of a liquid, which may contain gaseous nitric oxide and exhibit high humidity values in some cases. Non-limiting examples of suitable fluids may include, but are not limited to, exhaled breath for quantifying nitric oxide as a biomarker of diseases or conditions, such as lung or neurological diseases; air, freshwater, or seawater environmental monitoring; or industrial process effluents and process streams, such as flue gas and other combustion products, wastewater, or aqueous discharge streams. The amount of nitric oxide in the fluid may be in the ppm (parts per million by weight) level or below, or even in the ppb (parts per billion by weight) level or below.

The electrical response may include at least one electrical property, such as resistance, current, voltage, or any combination thereof, that is monitored or measured in conjunction with a concentration of nitric oxide in the fluid. More specifically, the at least one electrical property may be measured when the composite is contacting a fluid containing nitric oxide and measured relative to a baseline value when the composite is not contacting the fluid and the sensor has regenerated (or the composite is contacting another suitable reference fluid and the sensor is in a known initial state). That is, a change in the at least one electrical property may be measured relative to when the sensor is interacting with the fluid containing nitric oxide compared to when it is not or when the sensor is at some other known initial state. For example, the sensor may be exposed to a first set of conditions that is a background state having a low nitric oxide concentration and a second set of conditions having a high nitric oxide concentration. Once determined, the change in the at least one electrical property may be correlated with a concentration of nitric oxide that is present in the fluid, such as by consulting a lookup table or database, or by utilizing a calibration function that relates the change in the at least one electrical property to the nitric oxide concentration over a range of concentration values.

Selection of a suitable calibration function or lookup table may be based on knowledge of the humidity conditions to which the sensor is exposed, as the sensor response may vary depending on the humidity conditions. Accordingly, in some examples, methods of the present disclosure may further comprise measuring a relative humidity value in proximity to the composite while the composite is contacting the fluid comprising nitric oxide; and in which the relative humidity value is used to select a calibration function for determining a concentration of nitric oxide that is present in the fluid.

The present disclosure is further directed to the following non-limiting embodiments:

Embodiment 1. A sensor comprising:
an electrically conductive structure;
a composite in electrical communication with the electrically conductive structure, the composite comprising functionalized carbon nanotubes decorated with a plurality of metal nanoparticles; and
a humidity sensor in proximity to the composite.

Embodiment 2. The sensor of Embodiment 1, wherein the functionalized carbon nanotubes comprise oxidized single-walled carbon nanotubes comprising a plurality of carboxylic acid moieties.

Embodiment 3. The sensor of Embodiment 2, wherein at least a portion of the carboxylic acid moieties are neutralized with a base.

Embodiment 4. The sensor of any one of Embodiments 1-3, wherein the composite comprises about 1 wt % to about 10 wt % metal nanoparticles, based on total mass of the composite.

Embodiment 5. The sensor of any one of Embodiments 1-4, wherein the metal nanoparticles comprise gold nanoparticles.

Embodiment 6. The sensor of any one of Embodiments 1-5, wherein the metal nanoparticles range from about 5 nm to about 50 nm in size.

Embodiment 7. The sensor of any one of Embodiments 1-6, wherein a concentration of metal nanoparticles in the composite is optimized to provide an electrical response that is correlatable to a concentration of nitric oxide exposed thereto.

Embodiment 8. The sensor of Embodiment 7, wherein the electrical response is correlatable to the amount of nitric oxide at up to about 97% relative humidity.

Embodiment 9. A sensor comprising:
an electrically conductive structure; and
a composite in electrical communication with the electrically conductive structure, the composite comprising a plurality of metal nanoparticles and oxidized carbon nanotubes comprising a plurality of carboxylic acid moieties;
   wherein the oxidized carbon nanotubes are decorated with the plurality of metal nanoparticles; and
   wherein a concentration of metal nanoparticles in the composite is optimized to provide an electrical response that is correlatable to a concentration of nitric oxide exposed thereto.

Embodiment 10. The sensor of Embodiment 9, wherein the oxidized carbon nanotubes comprise oxidized single-walled carbon nanotubes comprising a plurality of carboxylic acid moieties.

Embodiment 11. The sensor of Embodiment 10, wherein at least a portion of the carboxylic acid moieties are neutralized with a base.

Embodiment 12. The sensor of any one of Embodiments 9-11, wherein the composite comprises about 1 wt % to about 10 wt % metal nanoparticles, based on total mass of the composite.

Embodiment 13. The sensor of any one of Embodiments 9-12, wherein the metal nanoparticles comprise gold nanoparticles.

Embodiment 14. The sensor of any one of Embodiments 9-13, wherein the metal nanoparticles range from about 5 nm to about 50 nm in size.

Embodiment 15. The sensor of any one of Embodiments 9-14, further comprising: a humidity sensor in proximity to the composite. Embodiment 16. The sensor of any one of Embodiments 9-15, wherein the electrical response is correlatable to the amount of nitric oxide at up to about 97% relative humidity.

Embodiment 17. A method comprising:
providing a sensor comprising an electrically conductive structure and a composite in electrical communication with the electrically conductive structure;
   wherein the composite comprises functionalized carbon nanotubes decorated with a plurality of metal nanoparticles;
contacting a fluid comprising nitric oxide with the composite;
determining an electrical response of the composite upon contacting the fluid therewith; and
correlating the electrical response with a concentration of nitric oxide present in the fluid.

Embodiment 18. The method of Embodiment 17, wherein the functionalized carbon nanotubes comprise oxidized single-walled carbon nanotubes comprising a plurality of carboxylic acid moieties.

Embodiment 19. The method of Embodiment 18, wherein at least a portion of the carboxylic acid moieties are neutralized with a base.

Embodiment 20. The method of any one of Embodiments 17-19, wherein the composite comprises about 1 wt % to about 10 wt % metal nanoparticles, based on total mass of the composite.

Embodiment 21. The method of any one of Embodiments 17-20, wherein the metal nanoparticles comprise gold nanoparticles.

Embodiment 22. The method of any one of Embodiments 17-21, wherein the metal nanoparticles range from about 5 nm to about 50 nm in size.

Embodiment 23. The method of any one of Embodiments 17-22, wherein the fluid is a gas, and the gas comprises gaseous nitric oxide.

Embodiment 24. The method of any one of Embodiments 17-22, wherein the fluid is a liquid, and the liquid contains dissolved nitric oxide.

Embodiment 25. The method of any one of Embodiments 17-24, further comprising: measuring relative humidity in proximity to the composite while the composite is contacting the fluid comprising nitric oxide; and selecting a calibration function for determining the amount of nitric oxide that is present in the fluid based upon the relative humidity value.

Embodiment 26. The method of any one of Embodiments 17-25, wherein the electrical response is correlatable to the amount of nitric oxide at up to about 97% relative humidity.

To facilitate a better understanding of the present disclosure, the following examples of preferred or representative embodiments are given. In no way should the following examples be read to limit, or to define, the scope of the invention.

EXAMPLES

Nanomaterial Syntheses. Single-walled carbon nanotubes (>90% purity) were purchased from US Research Nanomaterials, Inc. (Houston, TX). These nanotubes were further treated with sulfuric acid (98% wt., Sigma Aldrich) and nitric acid (68% wt., Sigma Aldrich) under known conditions to oxidatively open the ends of the carbon nanotubes and introduce oxygen-containing functional groups thereto, including carboxylic acid groups and hydroxyl groups. Such functionalized carbon nanotubes are referred to hereinafter as COOH-SWNTs. In brief, about 30 mg of pristine SWNTs were placed in a flask, and 40 mL of mixed sulfuric acid/nitric acid (3:1 volume ratio) was added. The reaction mixture was refluxed at 120° C. for 4 hours, diluted with de-ionized water, and finally centrifuged to recover the COOH-SWNTs. The material was further washed with de-ionized water until the pH value of the filtrate became neutral. The COOH-SWNTs were finally dispersed (0.03% by weight) in deionized water and sonicated for about 30 min.

Gold nanoparticles were synthesized by the Turkevich method. All the glassware and magnetic stirrers were thoroughly cleaned with aqua regia (1:3 mixture of nitric acid and hydrochloric acid on a molar basis) and then rinsed with de-ionized water. Gold (III) chloride hydrate (HAuCl₄) and trisodium citrate (Na₃C₆H₅O₇) were purchased from Sigma Aldrich(Burlington, MA). A 1 mM HAuCl₄ solution (80 ml) heated to a boiling temperature in a flask under uniform stirring. After reflux started, a 38.8 mM Na₃C₆H₅O₇ solution (9 mL) was slowly added. The color of the reaction mixture changed from yellow to dark purple. After about 40 minutes of reflux, the reaction mixture was slowly cooled to room temperature. The product Au nanoparticles were collected by centrifugation and stored in a dark place to minimize photooxidation.

Composites of the COOH-SWNTs and the Au nanoparticles were prepared by mixing the two components together at pH=7 and stirring overnight at room temperature. Three mixtures containing varying amounts of the Au nanoparticles relative to the COOH-SWNTs were prepared (1%, 5%, and 10% by weight relative to the COOH-SWNTs. The composite materials were stirred overnight at room temperature and used to prepare Sensors 2-4 below.

Another sample was prepared in the same manner, except the pH was adjusted to 10 using NaOH to deprotonate at least a portion of the carboxylic acid groups upon the COOH-SWNTs. In this case, an Au nanoparticle concentration of 5% by weight relative to the COOH-SWNTs was used. The neutralized composite material was stirred overnight and used to prepare Sensor 5 below.

Sensor Preparation and Characterization. The substrate of the sensor was FR-4 containing an array of 16 gold-printed interdigitated electrodes (IDEs). The IDEs were microfabricated by screen printing on a 2×1 cm² chip area. Each IDE had a finger width of 70 μm and a gap size of 102 μm.

The Au nanoparticle/COOH-SWNT composites were manually drop cast onto an IDE using 0.3 μL of the dispersions prepared as above. The sensor array was air dried overnight to evaporate the solvent, leaving the Au nanoparticle/COOH-SWNT composites bridging the fingers of the IDEs. This nanoarchitecture provides a high surface area and continuous electrical connectivity between the fingers of IDEs.

The composites of Sensors 3 and 5 were characterized by scanning electron microscopy (images not shown). The COOH-SWNTs appeared as a tangled network of bundles containing multiple nanotubes, which were densely aggregated to make a cluster. The average diameter of the COOH-SWNTs before and after forming the composites was around 6-10 nm and the length of the bundles was 0.1-1 μm. The surface was rough and displayed fragmentation, as is typically characteristic for COOH-SWNTs. SEM images of the Au nanoparticles alone showed diameters of about 15-20 nm and minimal particle agglomeration. The Au nanoparticles were attached to the COOH-SWNTs in the composites.

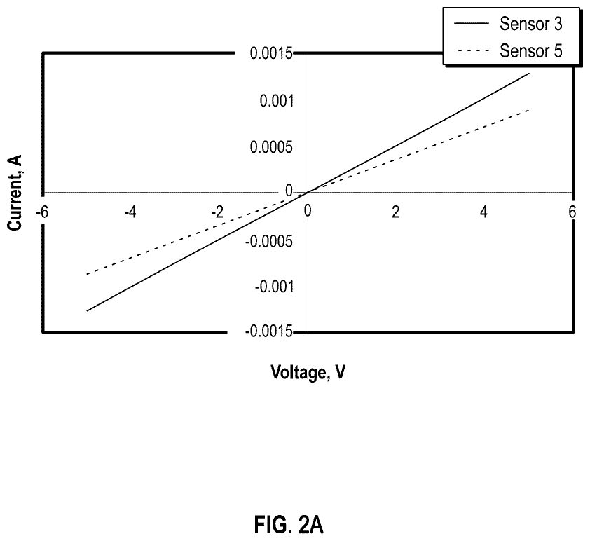

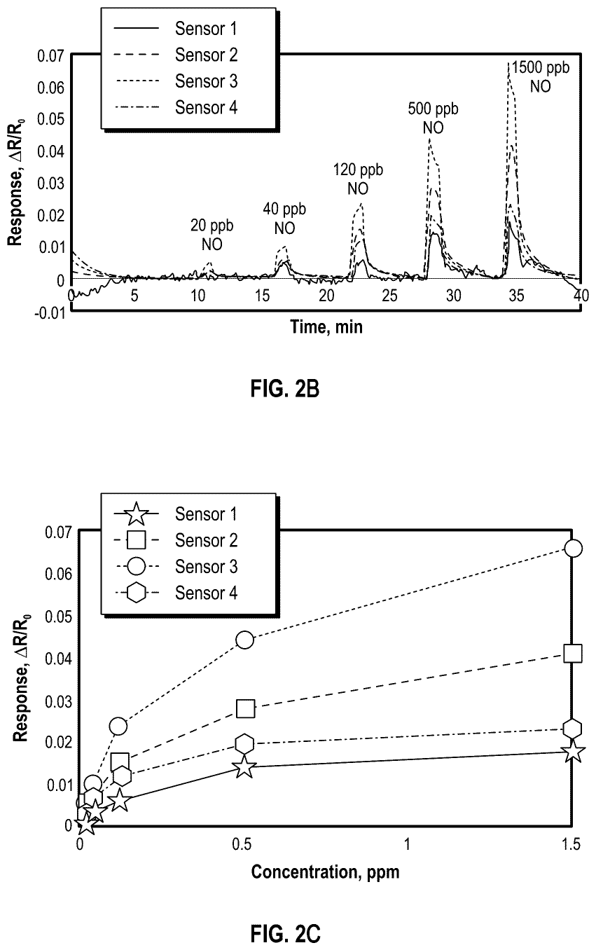

Current versus potential was measured using a HP Semiconductor Analyzer 4155A at ambient temperature and ambient room humidity for Sensors 3 and 5. FIG. 2A is a plot of current versus potential for Sensors 3 and 5. As illustrated, Sensor 3 had a higher conductivity than did Sensor 5 under the testing conditions.

Nitric Oxide Sensing. Gas sensing experiments were carried out by sequential exposure of the sensors to various concentrations of certified NO gas (2.5 ppm balanced in nitrogen, Praxair) received from a cylinder. An Environics 2000 (Environics Inc., Tolland, CT) gas blending and dilution system was used for producing desired concentrations of nitric oxide at varying humidity levels. Electrical resistance measurements of each sensor channel were conducted by connecting the sensor array to a Keithley 2700 device (Keithley Instruments, Inc., Scottsdale, AZ) via an interface board. A constant 400 CCM sample flow containing the desired concentration of nitric oxide gas was introduced to the sensor array in a small chamber having a Teflon cover overlaying the sensor array to evenly disburse the gas steam to all sensor channels. Exposure to nitric oxide was conducted after 10 minutes of nitrogen flow for baseline stabilization and humidity stabilization. To monitor temperature and humidity around the sensor area, a surface mount humidity and temperature sensor (Texas Instruments, HDC 1000YPAT) was placed next to the sensor array under the Teflon cover and humidity was adjusted from 0-97%. Resistance measurements were conducted during 1 minute of nitric oxide exposure. After measurement, the sensor array was purged with nitrogen for 5 minutes to regenerate the sensor before subsequent testing. The sensor response time was typically less than about 10 seconds, and the recovery time during nitrogen purging was around 1 minute.

The resistance of the sensors in the absence of nitric oxide varied with the Au nanoparticle loading, as shown in Table 1 below. As demonstrated, the conductivity of the sensors increased with the loading of the Au nanoparticles.

TABLE 1

| | Au Nanoparticle | Dispersion | Baseline | |
|---|---|---|---|---|
| Sensor No. | Loading (wt %) | pH | Resistance | |
| 1 | 0 | 7 | 30 | kΩ |
| (Control) | | | | |
| 2 | 1 | 7 | 11 | kΩ |
| 3 | 5 | 7 | 1.8 | kΩ |
| 4 | 10 | 7 | 624 | Ω |
| 5 | 5 | 10 | ~429 | Ω |

Results. The various sensors were first tested with variable concentrations of nitric oxide (0.02 ppm-1.5 ppm) in a nitrogen background at room temperature. Results are shown in FIG. 2B, which is a plot of normalized sensor response as a function of time illustrating the response of Sensors 1-4 in a nitrogen background (0% relative humidity). As shown, the response increased with increasing nitric oxide exposure. FIG. 2C is a corresponding plot of response as a function of nitric oxide concentration for Sensors 1-4 in a nitrogen background. As illustrated, Sensor 3 (5% Au nanoparticles) demonstrated the highest response under dry conditions. 10% Au nanoparticles produced a lower response.

Sensor 3 was also tested at lower nitric oxide concentrations down to 10 ppb, with an observable signal still being present. Therefore, the detection limit of the sensors toward nitric oxide is at least 10 ppb and perhaps lower.

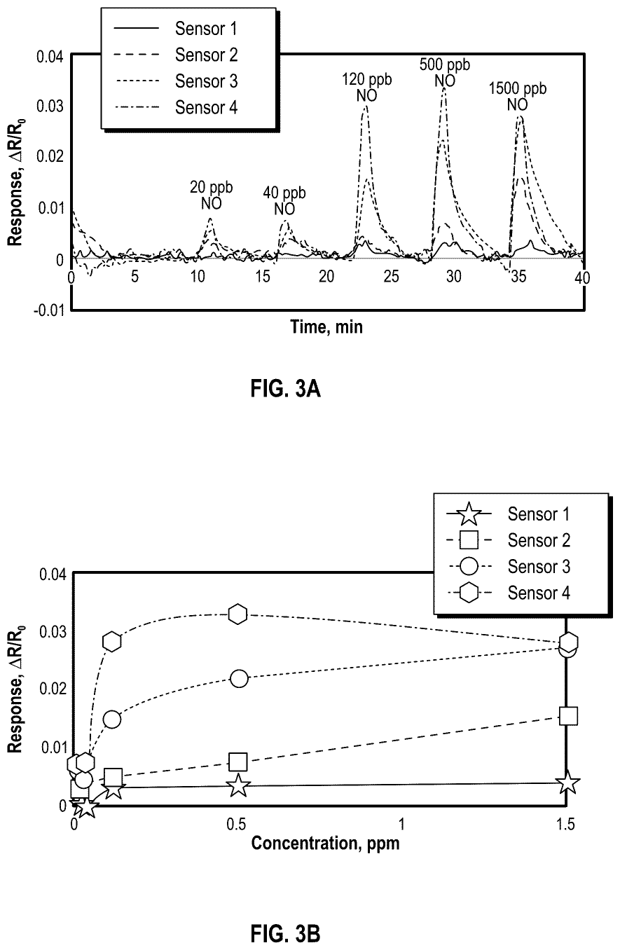

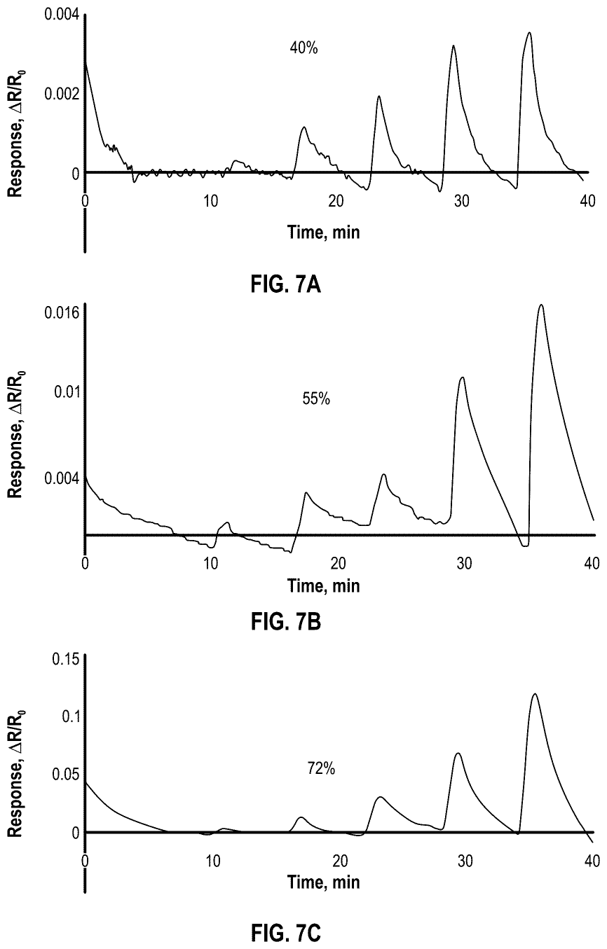

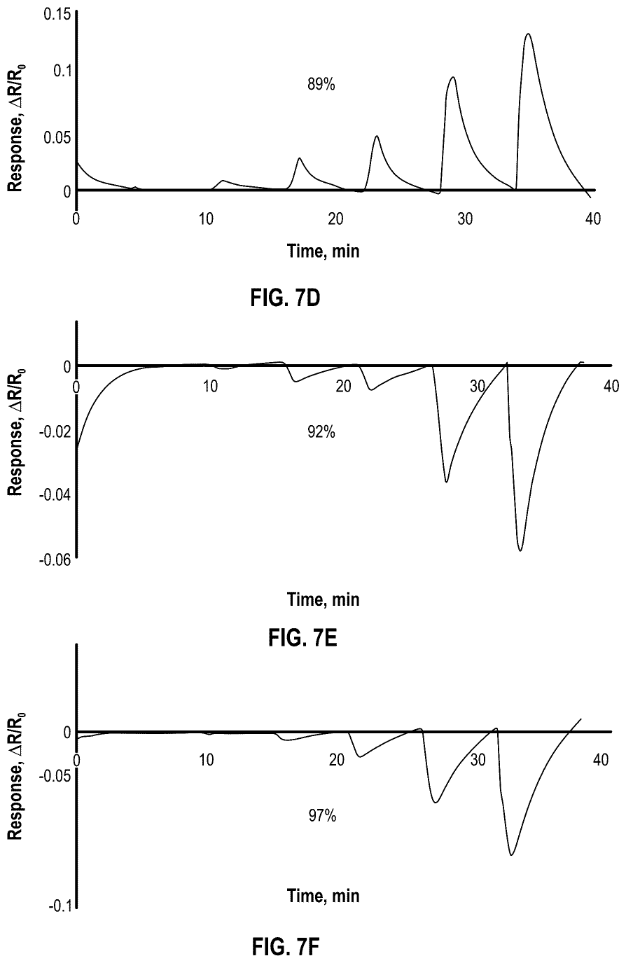

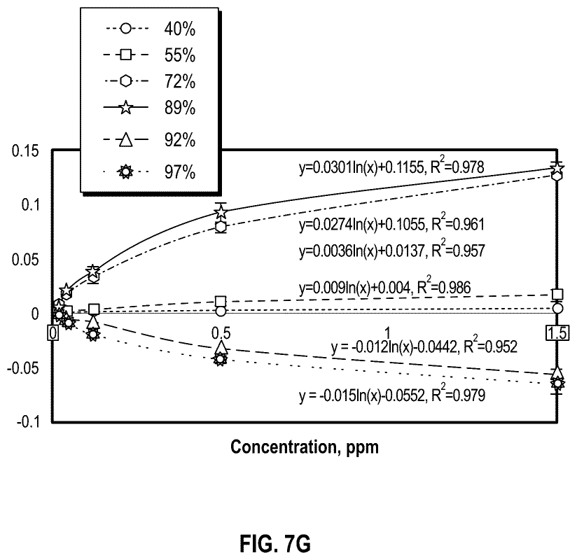

Sensors 1-4 were also tested under the same nitric oxide concentrations except at 92% relative humidity at room temperature. FIG. 3A is a plot of normalized sensor response as a function of time for Sensors 1-4 at 92% relative humidity. FIG. 3B is a corresponding plot of response as a function of nitric oxide concentration for Sensors 1-4 at 92% relative humidity. As illustrated, Sensor 4 (10% Au nanoparticles) demonstrated the highest response under humid conditions, but the response was not concentration-dependent and became saturated above 0.12 ppm nitric oxide. Sensor 3 (5% Au nanoparticles), in contrast, again displayed a concentration-dependent response over the tested range of nitric oxide concentrations. Performance of Sensor 5 (5% Au nanoparticles and partially neutralized) is discussed below in reference to FIG. 7.

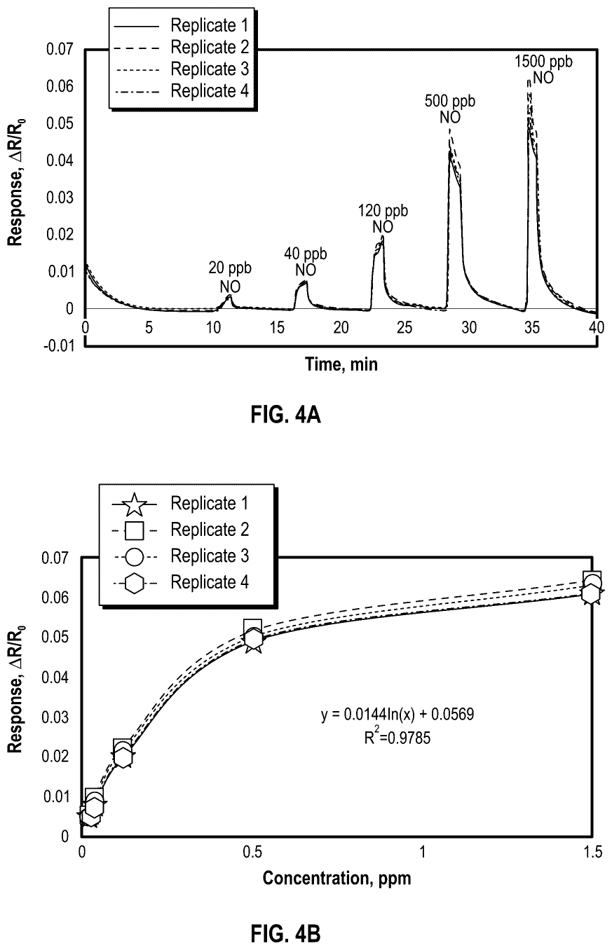

The reproducibility of the sensor response for multiple replicates of Sensor 3 was also tested. Four replicates of Sensor 3 were exposed to variable concentrations of nitric oxide (20 ppb-1500 ppb) in a nitrogen background at room temperature. Results are shown in FIG. 4A, which is a plot of normalized sensor response as a function of time for four replicates of Sensor 3 in a nitrogen background (0% relative humidity). As shown, the normalized sensor response was reproducible among replicates and increased with increasing nitric oxide concentration. The standard deviation of the normalized sensor response was calculated at 1.81%. FIG. 4B is a corresponding plot of response as a function of nitric oxide concentration for four replicates of Sensor 3 in a nitrogen background. The depicted calibration function is an average associated with the four replicates. The sensor response was linear at low concentrations (<˜400 ppb), whereas the response followed a natural logarithm function above this threshold. A linear calibration function may be obtained by plotting the normalized sensor response as a function of the natural logarithm of the nitric oxide concentration.

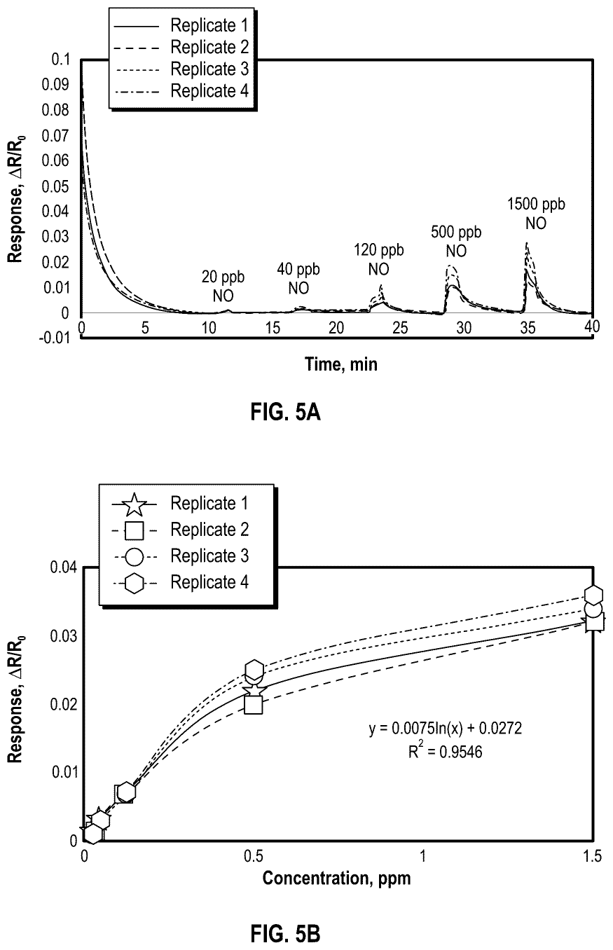

Sensor 5 was more tolerant toward humidity than was Sensor 3. Accordingly, the reproducibility of the sensor response for multiple replicates of Sensor 5 was also tested in humid conditions. Four replicates of Sensor 5 were exposed to variable concentrations of nitric oxide (20 ppb-1500 ppb) at 97% relative humidity at room temperature. Results are shown in FIG. 5A, which is a plot of normalized sensor response as a function of time for four replicates of Sensor 5 in 97% relative humidity. As shown, the normalized sensor response was reproducible among replicates and increased with increasing nitric oxide concentration, though the response was somewhat lower than that of Sensor 3 at equivalent nitric oxide concentrations, especially at the lowest nitric oxide concentrations. The standard deviation of the normalized sensor response was calculated at 5.52%. The baseline drift for Sensor 5 is believed to result from the changing humidity conditions from the nitrogen purge conducted before and after nitric oxide exposure (0% relative humidity during nitrogen purging) to the tested 97% relative humidity during nitric oxide exposure. FIG. 5B is a corresponding plot of response as a function of nitric oxide concentration for four replicates of Sensor 5 at 97% relative humidity. The depicted calibration function is an average associated with the four replicates. A linear calibration function may be obtained by plotting the normalized sensor response as a function of the natural logarithm of the nitric oxide concentration.

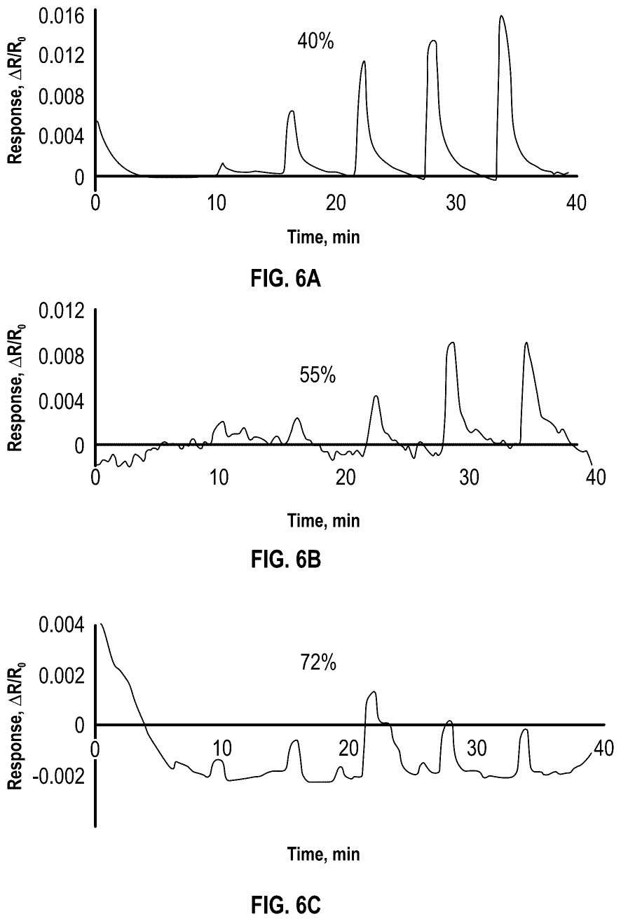

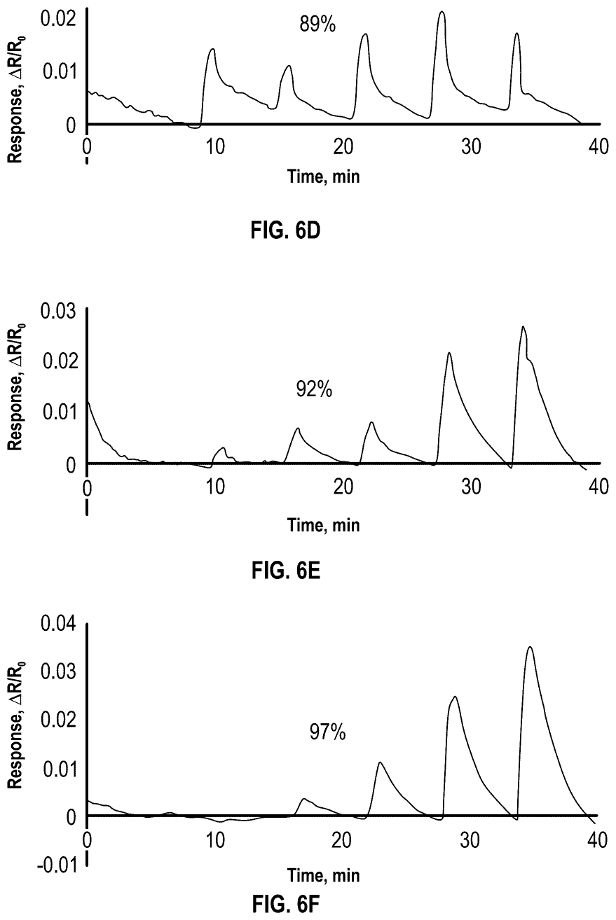

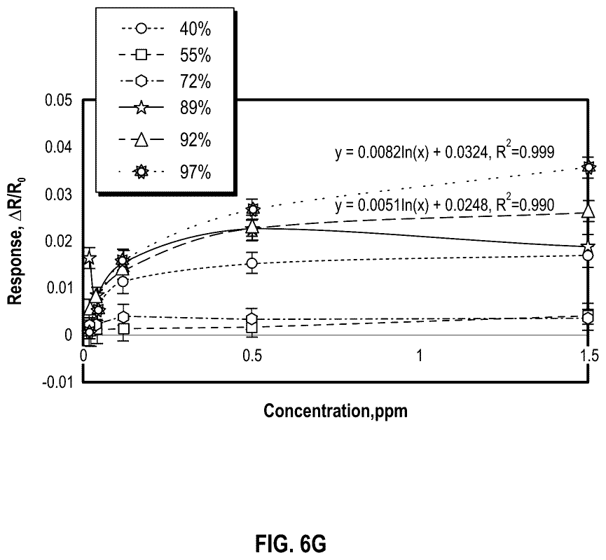

The performance of Sensor 3 and Sensor 5 was also tested under variable humidity conditions (40%, 55%, 72%, 89%, 92%, and 97%) when exposed to a range of nitric oxide concentrations (20 ppb-1500 ppb). FIGS. 6A-6F are plots of normalized sensor response for Sensor 3 under variable humidity conditions. The relative humidity is shown on each plot. FIG. 6G is a corresponding plot of normalized sensor response as a function of nitric oxide concentration for Sensor 3 under variable humidity conditions. The calibration functions at 92% and 97% relative humidity are shown. FIGS. 7A-7F are plots of normalized sensor response for Sensor 5 under variable humidity conditions. The relative humidity is shown on each plot. Surprisingly, the sign of the sensor response for Sensor 5 changed at higher relative humidity values. FIG. 7G is a corresponding plot of normalized sensor response as a function of nitric oxide concentration for Sensor 5 under variable humidity conditions. The calibration functions at each relative humidity value tested are shown. As shown, Sensor 3 demonstrated good sensitivity at 40%, 92% and 97% relative humidity, but in the intermediate range of 55%-89% relative humidity, the response was noisy and variable and not concentration-dependent. Sensor 5, in contrast, demonstrated sensitivity to nitric oxide over the tested range of relative humidity values. The normalized sensor response for both Sensor 3 and Sensor 5 was low at intermediate relative humidity values and increased as the relative humidity became higher. For example, the normalized sensor response for Sensor 3 increased by about a factor of 10 at 89% relative humidity, whereas the normalized sensor response for Sensor 5 demonstrated a similar increase at 72% relative humidity. In view of these results, the chemical makeup of the composites may be selected based upon the anticipated humidity conditions to which the sensor will be exposed. Sensor 3 may provide a stronger response under dry conditions, whereas Sensor 5 may afford a reliable response over a considerably greater range of relative humidity conditions.

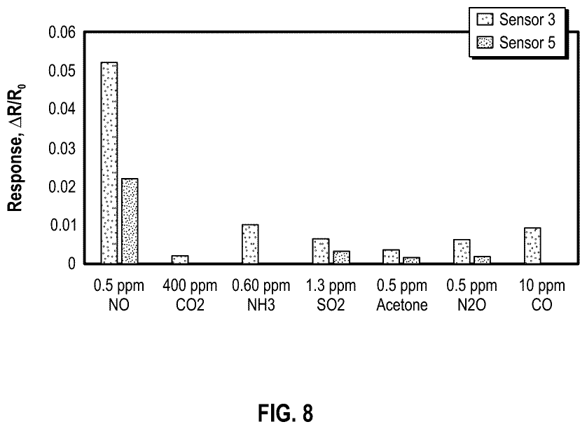

The normalized sensor responses for various environmental gases (CO₂, NH₃, SO₂, acetone, N₂O, and CO) was also determined for Sensors 3 and 5 to evaluate selectivity of the sensors in comparison to nitric oxide. Rather than utilize a fixed concentration of the environmental gases, the sensors were exposed to a concentration of each of the environmental gases commonly found in the atmosphere against an air background. Measurements in this case were made at 0% relative humidity. FIG. 8 is a bar graph showing the normalized sensor response for Sensors 3 and 5 when exposed to various environmental gases at 0% relative humidity. As shown, the nitric oxide response was considerably higher than that of the other environmental gases for both sensors. Sensor 3 exhibited at least some response for all of the environmental gases, again at a considerably lower level than for nitric oxide, whereas no signal was received for CO₂, NH₃, and CO for Sensor 5. For Sensor 5, the SO₂ signal decreased in about the same proportion as did the nitric oxide signal, but was still observable. Acetone and N₂O appeared to decrease in a greater proportion than did the nitric oxide signal.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

The invention claimed is:

1. A sensor comprising:
an electrically conductive structure;
a composite in electrical communication with the electrically conductive structure, the composite comprising:
functionalized carbon nanotubes decorated with a plurality of metal nanoparticles;
wherein the functionalized carbon nanotubes comprise oxidized single-walled carbon nanotubes comprising a plurality of carboxylic acid moieties.

2. The sensor of claim 1, further comprising a humidity sensor in proximity to the composite.

3. The sensor of claim 1, wherein at least a portion of the carboxylic acid moieties are neutralized with a base.

4. The sensor of claim 1, wherein the composite comprises about 1 wt % to about 10 wt % metal nanoparticles, based on total mass of the composite.

5. The sensor of claim 1, wherein the metal nanoparticles comprise gold nanoparticles.

6. The sensor of claim 1, wherein the metal nanoparticles range from about 5 nm to about 50 nm in size.

7. The sensor of claim 1, wherein a concentration of metal nanoparticles in the composite is optimized to provide an electrical response that is correlatable to a concentration of nitric oxide exposed thereto.

8. The sensor of claim 7, wherein the electrical response is correlatable to the amount of nitric oxide at up to about 97% relative humidity.

9. A sensor comprising:
an electrically conductive structure; and
a composite in electrical communication with the electrically conductive structure, the composite comprising a plurality of metal nanoparticles and oxidized carbon nanotubes comprising a plurality of carboxylic acid moieties;
wherein the oxidized carbon nanotubes are decorated with the plurality of metal nanoparticles; and
wherein a concentration of metal nanoparticles in the composite is optimized to provide an electrical response that is correlatable to a concentration of nitric oxide exposed thereto.

10. The sensor of claim 9, wherein the oxidized carbon nanotubes comprise oxidized single-walled carbon nanotubes comprising a plurality of carboxylic acid moieties.

11. The sensor of claim 10, wherein at least a portion of the carboxylic acid moieties are neutralized with a base.

12. The sensor of claim 9, wherein the composite comprises about 1 wt % to about 10 wt % metal nanoparticles, based on total mass of the composite.

13. The sensor of claim 9, wherein the metal nanoparticles comprise gold nanoparticles.

14. The sensor of claim 9, wherein the metal nanoparticles range from about 5 nm to about 50 nm in size.

15. The sensor of claim 9, further comprising:
a humidity sensor in proximity to the composite.

16. The sensor of claim 9, wherein the electrical response is correlatable to the amount of nitric oxide at up to about 97% relative humidity.

17. A method comprising:
providing a sensor comprising an electrically conductive structure and a composite in electrical communication with the electrically conductive structure;
wherein the composite comprises functionalized carbon nanotubes decorated with a plurality of metal nanoparticles;
contacting a fluid comprising nitric oxide with the composite;
determining an electrical response of the composite upon contacting the fluid therewith; and
correlating the electrical response with a concentration of nitric oxide present in the fluid.

18. The method of claim 17, wherein the functionalized carbon nanotubes comprise oxidized single-walled carbon nanotubes comprising a plurality of carboxylic acid moieties.

19. The method of claim 18, wherein at least a portion of the carboxylic acid moieties are neutralized with a base.

20. The method of claim 17, wherein the composite comprises about 1 wt % to about 10 wt % metal nanoparticles, based on total mass of the composite.

21. The method of claim 17, wherein the metal nanoparticles comprise gold nanoparticles.

22. The method of claim 17, wherein the metal nanoparticles range from about 5 nm to about 50 nm in size.

23. The method of claim 17, wherein the fluid is a gas, and the gas comprises gaseous nitric oxide.

24. The method of claim 17, wherein the fluid is a liquid, and the liquid contains dissolved nitric oxide.

25. The method of claim 17, further comprising:
measuring relative humidity in proximity to the composite while the composite is contacting the fluid comprising nitric oxide; and
selecting a calibration function for determining the amount of nitric oxide that is present in the fluid based upon the relative humidity value.

26. The method of claim 17, wherein the electrical response is correlatable to the amount of nitric oxide at up to about 97% relative humidity.
